(19) United States
(12) Patent Application Publication
(10) Pub. No.: US 2016/0187579 A1
(43) Pub. Date: Jun. 30, 2016

(54) WAVEGUIDE ARRANGEMENT

(71) Applicants: HUMBOLDT-UNIVERSITÄT ZU BERLIN, Berlin (DE); FORSCHUNGSVERBUND BERLIN E.V., Berlin (DE)

(72) Inventors: Rico HENZE, Prenzlau (DE); Andreas THIES, Berlin (DE); Oliver BENSON, Berlin (DE)

(73) Assignees: Forschungsverbund Berlin e.V., Berlin (DE); Humboldt-Universitaet zu Berlin, Berlin (DE)

(21) Appl. No.: 14/650,711

(22) PCT Filed: Nov. 26, 2013
(86) PCT No.: PCT/DE2013/200319

§ 371 Date: Jun. 9, 2015

(30) Foreign Application Priority Data
Dec. 12, 2012 (DE) 10 2012 222 898.5

(51) Int. Cl. G02B 6/122; G02B 6/136

(52) U.S. Cl. CPC G02B 6/122; G02B 6/136; G02B 2006/121

(57) ABSTRACT

The invention relates to a waveguide arrangement (10) comprising a substrate (20) and at least one strip-shaped waveguide made of a wave-guiding layer material (30). The strip waveguide extends strip-like in a longitudinal direction and can guide waves in its longitudinal direction so that the wave propagation direction corresponds to the longitudinal direction of the strip waveguide. The refractive index of the substrate (20) is greater than the refractive index of the layer material (30). In order to guide waves vertically, the strip waveguide forms a waveguide bridge (60) which is located above a recess (100) in the substrate (20) and which is at least partially spatially separated from the substrate (20) there.

The invention relates to a waveguide arrangement having a substrate and at least one strip-shaped waveguide consisting of a waveguiding layer material, wherein the strip waveguide extends in the shape of a strip along a longitudinal direction and can guide waves along its longitudinal direction in such a way that the wave propagation direction corresponds to the longitudinal direction of the strip waveguide. The term waveguide is intended here to mean waveguides which can guide electromagnetic radiation, in particular optical radiation (for example visible or invisible light) along their longitudinal direction. Such waveguides are also referred to in technical terminology as light waveguides.

Such a waveguide arrangement is known from European Patent 0 837 352 B1. The waveguide arrangement is based on SOI (silicon on insulator) material, which consists of a silicon substrate, a silicon dioxide interlayer and a silicon cover layer. A rib structure is etched into the silicon cover layer, so that a strip waveguide in the form of a rib waveguide is formed. The vertical waveguiding is based on a refractive index difference between the silicon cover layer and the silicon dioxide interlayer.

Another concept for waveguiding and the production of waveguides is based on the expedient combination of materials with different refractive indices in order to construct a layered carrier structure. In these anti-resonant reflecting optical waveguides (abbreviated to ARROWs), the refractive index of the waveguide may also be less than that of the substrate carrying the waveguide. With this type of waveguiding, however, the waveguide does not bear directly on the substrate, but is separated therefrom alternately by thin layers as well as materials with a high and low refractive index. By this layering, a kind of mirror is formed, which makes it possible to permit localized waveguiding of the waveguide in relation to the actual substrate.

Another waveguiding method consists in configuring a waveguide as a two-dimensional photonic crystal structure. In two-dimensional photonic crystal structures, band effects are used. In general, a plurality of rows of mutually offset round holes inside the waveguiding waveguide layer, which generate the functionality of the waveguide by their size, shapes and distribution in the layer, are used.

The object of the present invention is to provide a waveguide arrangement which can be produced simply and/or economically and allows waveguiding even when the refractive index of the waveguide material is less than the refractive index of the underlying substrate.

This object is achieved according to the invention by a waveguide arrangement having the features according to patent claim 1. Advantageous configurations of the waveguide arrangement according to the invention are specified in the dependent claims.

Accordingly, the invention provides a waveguide arrangement having a substrate and at least one strip-shaped strip waveguide consisting of a waveguiding layer material, wherein the strip waveguide extends in the shape of a strip along a longitudinal direction and can guide waves along its longitudinal direction in such a way that the wave propagation direction corresponds to the longitudinal direction of the strip waveguide, wherein the refractive index of the substrate is greater than the refractive index of the layer material, and wherein the strip waveguide forms a waveguide bridge for vertical waveguiding which is arranged above a recess in the substrate and is spatially separated there from the substrate at least in sections.

One essential advantage of the waveguide arrangement according to the invention is that it allows waveguiding of waves in layer material with a refractive index which is less than that of the substrate carrying the layer material. It is therefore possible to guide the light in material that is particularly well matched to other components in terms of refractive index. For example, it is possible to select as layer material a glass material whose refractive index corresponds to the refractive index of conventional light waveguide fibers. By the waveguide bridge formation provided according to the invention—in contrast to the waveguide concept mentioned in the introduction—it is not necessary to separate the strip waveguide from the substrate by interlayers and/or to select a substrate having a particularly low refractive index.

In order to permit stable bridge formation, according to a particularly preferred configuration of the waveguide arrangement, the layer material has, outside the region of the strip waveguide, at least one bearing section in which the layer material is carried indirectly or directly by the substrate, and the layer material forms, in the neighboring region next to the waveguide, at least one lateral holding web which extends transversely, in particular perpendicularly, to the longitudinal direction of the strip waveguide and therefore transversely to the wave propagation direction from the bearing section to the waveguide bridge, and which holds from the side the waveguide overhanging the substrate. By the provision of additional lateral holding webs, it is even possible to form particularly long waveguide bridges without running the risk of the waveguide bridge collapsing.

There are particularly preferably a multiplicity of lateral holding webs, each of the holding webs respectively being bounded by two neighboring holes, lying behind one another along the wave propagation direction, which extend through the layer material into the substrate, separate the respective holding web from the underlying substrate and are connected to the recess under the waveguide bridge.

In order to avoid the lateral holding webs interfering with or attenuating the wave propagation in the longitudinal direction of the strip waveguide, it is regarded as advantageous for the layer thickness of the layer material in the region of the lateral holding webs and/or in the bearing section to be less than the thickness of the layer material in the waveguiding section of the strip waveguide. By a reduction of the layer thickness of the layer material in the region of the lateral holding webs and/or in the bearing section, lateral crosstalk of waves can in a very simple way be avoided or at least reduced.

The layer waveguide may be a rib waveguide which has a waveguiding section consisting of the layer material and two edge sections adjacent thereto consisting of the layer material, the waveguiding section having a first layer thickness and the two edge sections adjacent thereto having a second layer thickness smaller than this.

Preferably, the layer thickness of the edge sections corresponds to the layer thickness of the layer material in the bearing section and/or to the layer thickness of the holding webs.

It is regarded as particularly advantageous for the layer thickness of the layer material in the region of the holding webs to be between 5% and 50% of the thickness of the layer material in the waveguiding section of the strip waveguide.

Preferably, the thickness of the layer material in the region of the strip waveguide, particularly in its waveguiding section, is between 0.5 and 10 times the wavelength of the radiation guided in the strip waveguide.

Preferably, the width of the strip waveguide, particularly in its waveguiding section, is between 0.5 and 10 times the wavelength of the radiation guided in the strip waveguide.

With a view to particularly high stability of the waveguide bridge, it is furthermore regarded as advantageous for the waveguide bridge to be supported by at least one support which consists of substrate material, extends from the bottom of the recess to the waveguide bridge and supports the waveguide bridge from below.

Preferably, the at least one support is arranged perpendicularly to the longitudinal direction of the strip waveguide and perpendicularly to the wave propagation direction.

Particularly preferably, the waveguide arrangement has a multiplicity of supports, the distance between the neighboring supports being varied or constant.

With a view to the material system of the waveguide arrangement, it is regarded as advantageous for the substrate to be a silicon substrate and for the waveguiding layer material to consist of an oxide, in particular silicon dioxide, or a polymer, which preferably bears directly on the substrate.

Furthermore, regarded as advantageous as material systems are those systems in which a material that may potentially be used for light generation is combined with a material that is suitable for light guiding. Such combinations are for example GaAs and ternary compounds derived therefrom, such as AlGaAs or InGaAs, InP and ternary systems derived therefrom, such as InAlP, GaN and ternary systems derived therefrom, such as AlGaN, SiC and ternary systems derived therefrom, and for light guiding silicon oxides, aluminum oxides and DLC (diamond-like carbon) layers. In general, all layers that exhibit low attenuation at the wavelength to be guided may be used.

The invention furthermore relates to a method for producing a waveguide arrangement, wherein
at least one strip waveguide, which extends along a longitudinal direction and can guide waves along its longitudinal direction in such a way that the wave propagation direction corresponds to the longitudinal direction of the strip waveguide, is formed from at least one waveguiding layer material located indirectly or directly on a substrate, the waveguiding layer material having a lower refractive index than the substrate, and
at least one recess is introduced into the layer material and the substrate, and at least one waveguide bridge comprising the strip waveguide is produced, which waveguide bridge is spatially separated from the substrate at least in sections.

With respect to the advantages of the method according to the invention, reference is made to the comments above relating to the waveguide arrangement according to the invention, since the advantages of the waveguide arrangement according to the invention essentially correspond to those of the method according to the invention.

According to a particularly preferred configuration of the method, at least one bearing section, in which the layer material is carried indirectly or directly by a substrate, is produced with the layer material outside the region of the strip waveguide, and a multiplicity of lateral holding webs are produced, each of which extends transversely, in particular perpendicularly, to the longitudinal direction of the strip waveguide and therefore transversely to the wave propagation direction from the bearing section to the waveguide bridge and which holds from the side the waveguide overhanging the substrate, by etching holes lying behind one another along the wave propagation direction through the layer material into the substrate and etching under the region of the strip waveguide.

The invention will be explained in more detail below with the aid of an exemplary embodiment; by way of example

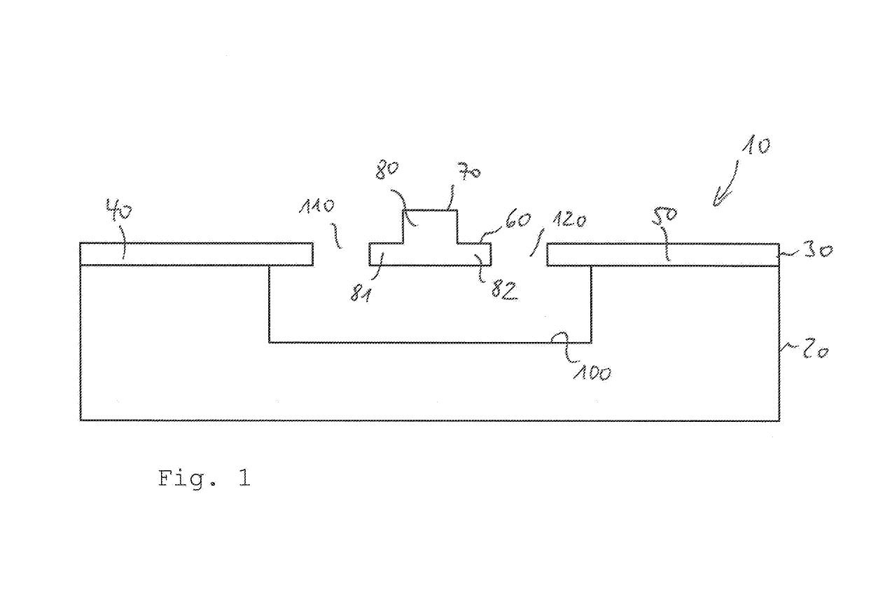

FIG. 1 shows a first exemplary embodiment of a waveguide arrangement having a freely suspended rib waveguide,

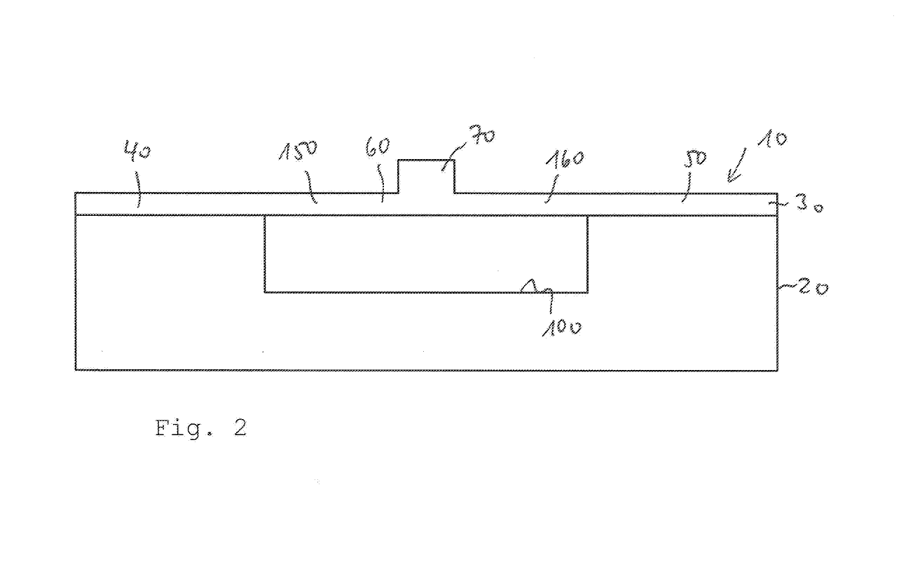

FIG. 2 shows an exemplary embodiment of a waveguide arrangement, in which a waveguide bridge is held by lateral holding webs,

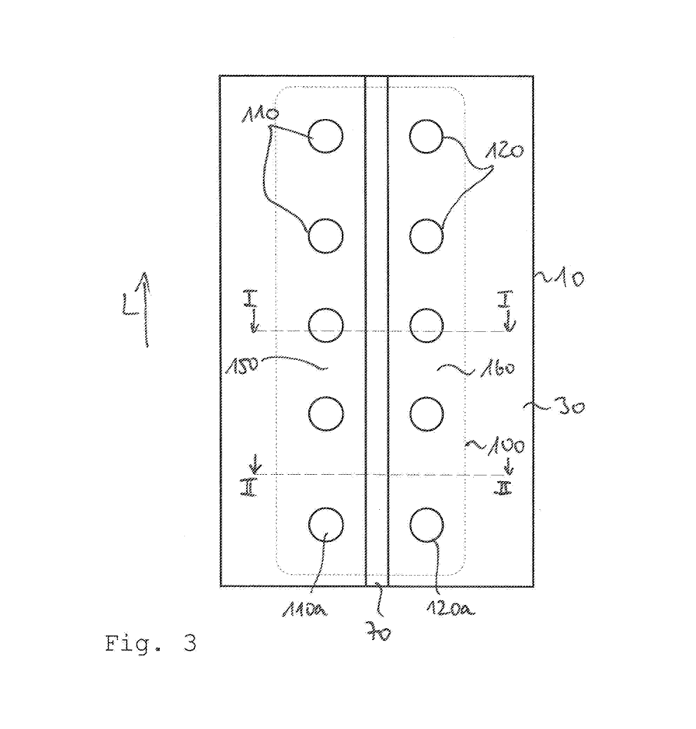

FIG. 3 shows another exemplary embodiment of a waveguide arrangement in a view from above,

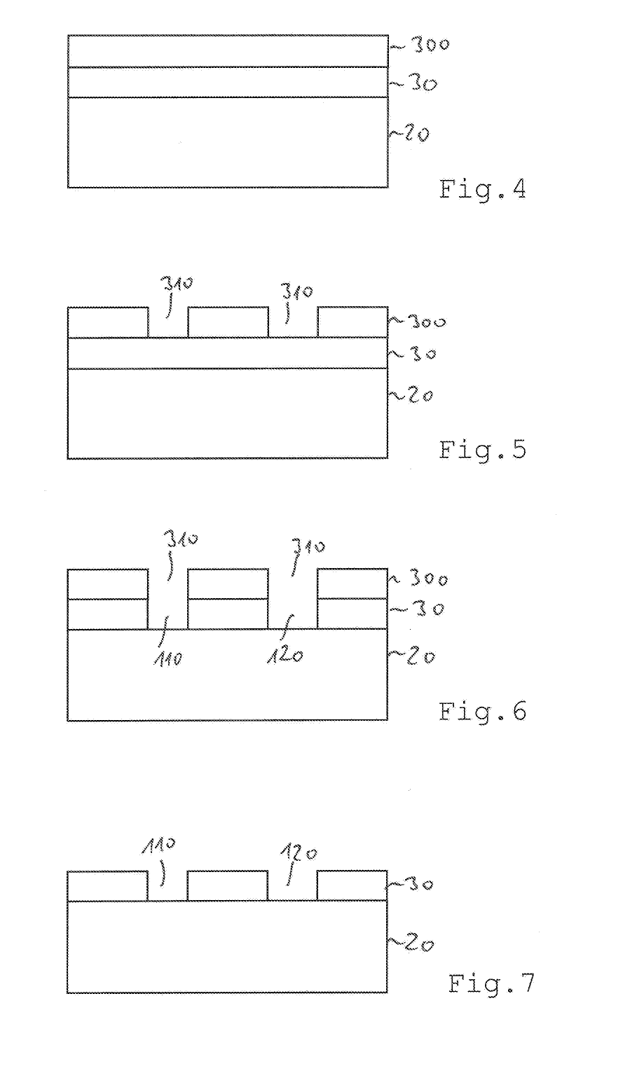

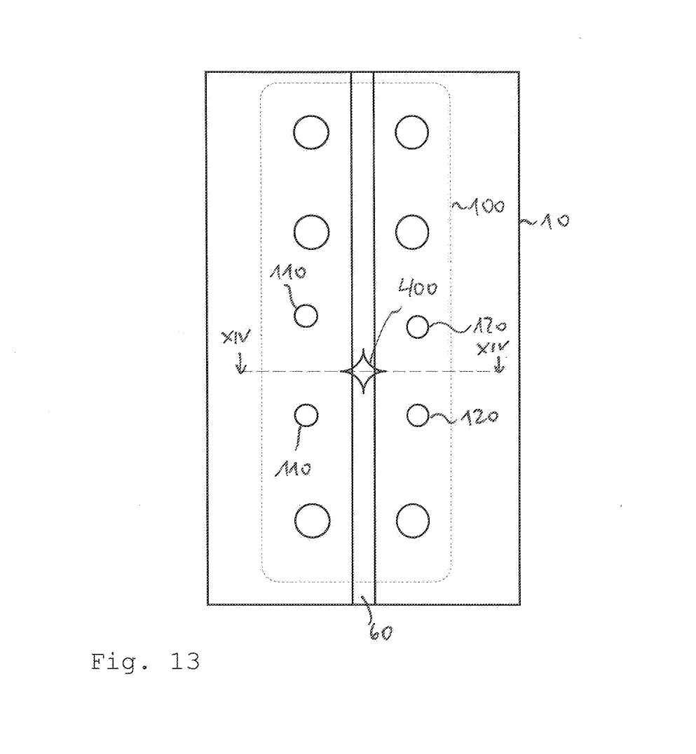

FIGS. 4 to 12 show by way of example a method for producing the waveguide arrangements according to FIGS. 1 to 3,

FIG. 13 shows an exemplary embodiment of a waveguide arrangement, in which one or more vertical supports are provided in order to support a waveguide bridge,

FIG. 14 shows the exemplary embodiment according to FIG. 13 in cross section

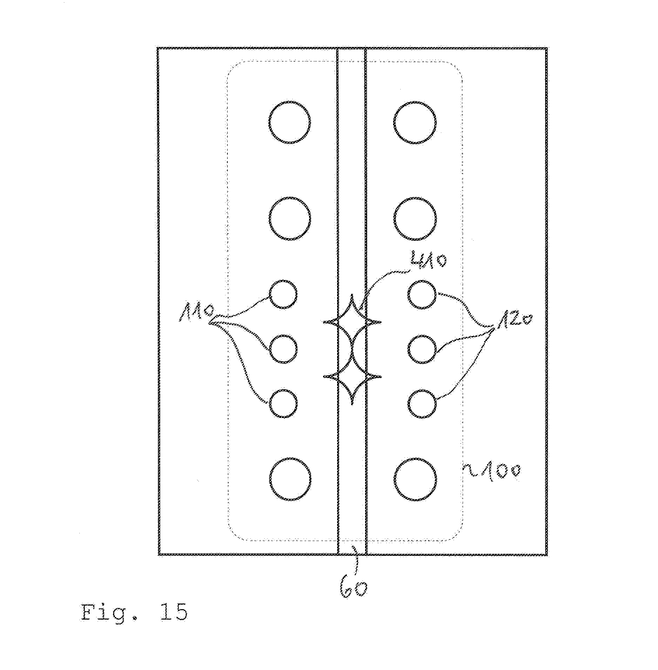

FIG. 15 shows an exemplary embodiment of a waveguide arrangement, in which a waveguide bridge is supported by one or more double supports, and

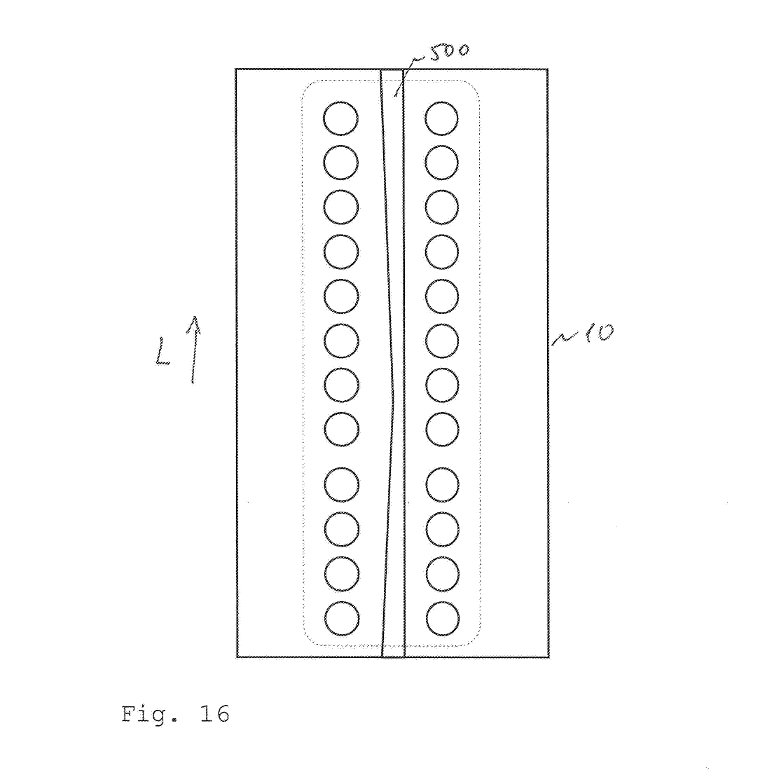

FIG. 16 shows a waveguide arrangement having a layer waveguide which first tapers and then widens again.

In the figures, for the sake of clarity, the same references are always used for identical or similar components.

FIG. 1 shows a waveguide arrangement 10, which is formed by a substrate 20 and a layer material 30 located on the substrate 20. In bearing sections 40 and of the layer material 30, the layer material 30 bears directly on the substrate 20.

A waveguide bridge 60, in which a layer waveguide is formed, for example in the form of a rib waveguide 70, is formed by the layer material 30. The waveguide bridge 60 extends perpendicularly to the plane of the drawing in the representation according to FIG. 1; the waveguide bridge 60 is therefore seen in a cross section perpendicular to the waveguide bridge longitudinal direction. The rib waveguide 70, the longitudinal direction of which in the representation according to FIG. 1 extends parallel to the longitudinal direction of the waveguide bridge 60, and therefore likewise perpendicularly to the plane of the drawing, comprises a waveguiding rib section 80 as well as two lateral edge sections 81 and 82. In the two edge sections 81 and 82, the thickness of the layer material 30 is less than in the waveguiding rib section 80, so that lateral waveguiding is ensured by the rib section 80. The propagation direction of the wave or waves guided by the rib waveguide 70 extends perpendicularly to the plane of the drawing in the representation according to FIG. 1.

FIG. 1 furthermore shows that the waveguide bridge 60 is separated from the substrate 20 in the vertical direction, since the substrate 20 has a recess 100 in the region of the waveguide bridge 60. The recess 100 may, for example, have been produced in the scope of an etching step by undercut etching starting from the holes 110 and 120 in the layer material 30. The recess 100 may be empty (vacuum) or filled with air or another filler material (for example gas, an adhesive material, etc.) so long as it has a refractive index less than that of the layer material 30.

In the waveguide arrangement 10, the refractive index of the layer material 30 is less than the refractive index of the substrate 20, so that vertical waveguiding would not be possible without a bridge design since the optical wave would otherwise be coupled into the substrate 20. By the recess 100, the rib waveguide 70 is separated from the substrate 20 so that the wave cannot be coupled from the rib waveguide 70 into the substrate 20. Vertical waveguiding is therefore achieved in the waveguide arrangement 10, even though the layer material 30 has a lower refractive index than the substrate 20.

FIG. 2 shows another exemplary embodiment of a waveguide arrangement 10, in which a layer material 30 is applied on a substrate 20. The layer material 30 has a lower refractive index than the substrate 20.

A rib waveguide 70, which forms a waveguide bridge 60 suspended over the substrate 20, is formed in the layer material 30. The rib waveguide 70 and the waveguide bridge 60 are arranged perpendicularly to the plane of the drawing in FIG. 2 (as previously in FIG. 1). In contrast to the exemplary embodiment according to FIG. 1, in the waveguide arrangement 10 according to FIG. 2 a lateral support of the waveguide bridge 60 over the recess 100 is produced by providing lateral holding webs 150 and 160, which extend from the two bearing sections 40 and 50 in the direction of the waveguide bridge 60 and which laterally hold the waveguide bridge 60, or the rib waveguide 70. Sagging of the waveguide bridge 60, or breaking of the waveguide bridge 60, in the direction of the substrate 20 is reduced or avoided by the lateral holding webs 150 and 160.

The production of the structure according to FIG. 2 may, for example, be carried out by first introducing the recess 100 into the substrate 20 and then filling it with a filler material (“sacrificial material”) not shown in FIG. 2. The layer material 30 is subsequently applied onto the substrate surface outside the recess 100 and onto the filler material in the region of the recess 100, and the rib waveguide 70 is formed. After the production of the rib waveguide 70, the filler material may be removed, whether thermally (for example by melting), by dissolving with a solvent or by etching.

In order to simplify the production of the recess 100 in the substrate 20, the waveguide bridge 60 is preferably not held everywhere by lateral holding webs 150 and 160, but only in sections. The waveguide arrangement 10 according to FIG. 2 therefore preferably will have a different structure at other positions, which are not shown in FIG. 2, for example a structure as shown in FIG. 1.

FIG. 3 shows a view from above of a waveguide arrangement 10 which, in cross section, resembles that in FIG. 1 in some sections and that in FIG. 2 in other sections. The layer material 30 can be seen, in which holes 110 and 120 that form two rows of holes 110a and 120a are formed. The two rows of holes 110a and 120a extend along the longitudinal direction L of the rib waveguide 70.

Through the holes 110 and 120, the substrate 20 can be removed locally in order to form the recess 100, for example by wet chemical or dry chemical etching (cf. FIGS. 1 and 2). The mutual spacing of the holes 110, the mutual spacing of the holes 120 and the etching behavior of the etchant establish whether and to what width the lateral holding webs 150 and 160 that locally hold the waveguide bridge 60 laterally are formed (cf. FIG. 2).

In the exemplary embodiment according to FIG. 3, the waveguide arrangement 10 at the cross-sectional line I-I corresponds in terms of cross section to the waveguide arrangement according to FIG. 1. At the cross-sectional area II-II, the lateral holding webs 150 and 160 are present, so that a cross section as shown in FIG. 2 results. In other words, by the arrangement of the holes 110 and 120, a waveguide arrangement 10 is obtained which corresponds in some sections to that in FIG. 1 and in other sections to that in FIG. 2.

In connection with FIGS. 4 to 12, an exemplary embodiment of the production of the waveguide arrangement according to FIG. 3 will be explained below:

First, a waveguiding layer material 30 is applied onto a substrate 20. In order to structure the layer material 30, a photoresist 300 is applied onto the layer material 30 (cf. FIG. 4).

FIG. 5 shows the structure after the photoresist 300 has been structured by means of a photolithographic step with the formation of openings 310.

By means of an etching process, the openings 310 are transferred into the layer material 30, so that holes 110 and 120 are formed in the layer material 30 (cf. FIGS. 3 and 6).

FIG. 7 shows the structure after the photoresist 300 has been removed.

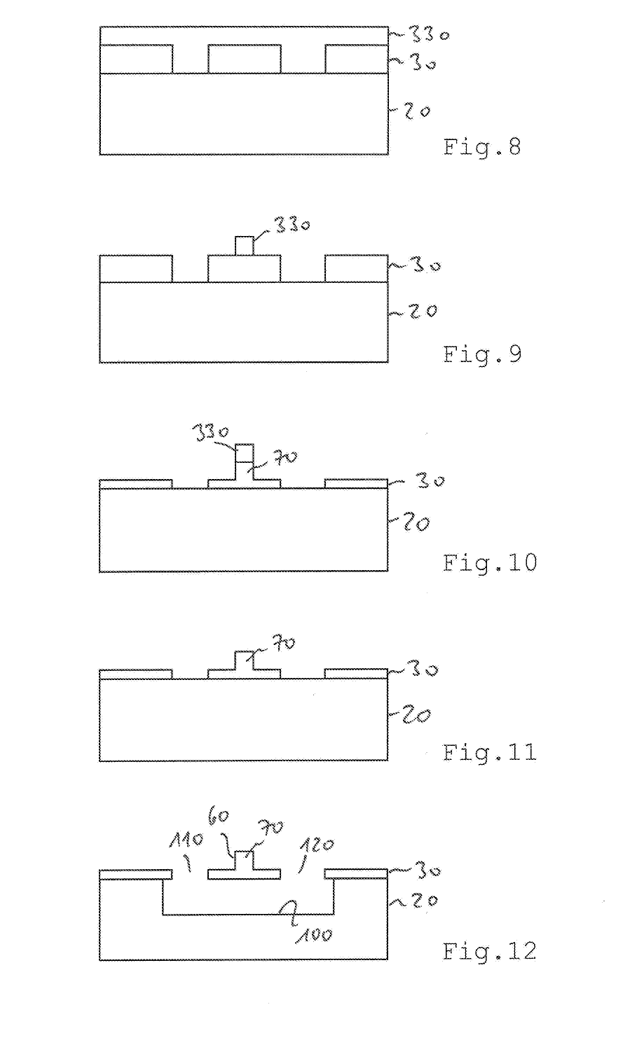

A further photoresist layer 330 is subsequently applied (cf. FIG. 8). After another lithography step, structuring of the further photoresist layer 330 is obtained for the purpose of forming the future waveguide 70 (cf. FIGS. 1, 2 and 9).

FIG. 10 shows the resulting structure after the layer material 30 has been partially removed, or thinned, by etching in the regions not covered by the further photoresist layer 330. It can be seen that the rib waveguide 70 is formed by the etching of the layer material 30.

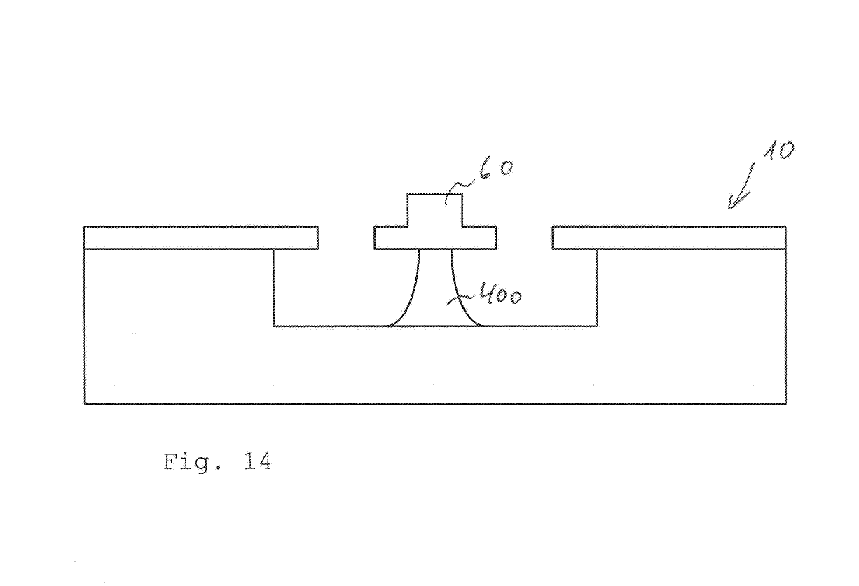

FIG. 11 shows the resulting structure after the further photoresist layer 330 has been removed.

In the scope of a further etching step, a recess 100 is etched through the holes 110 and 120 below the rib waveguide 70, so that a waveguide bridge 60 that hangs freely over the recess 100 in the substrate 20 is formed. FIG. 12 shows the resulting structure in cross section. The etching of the recess 100 below the waveguide bridge 60 is based on undercut etching by suitable selection of the etchant. The etchant may, for example, be an isotropic etchant.

FIG. 13 shows an exemplary embodiment of a waveguide arrangement 10, in which a vertical support 400 (or a plurality of vertical supports) consisting of substrate material, which mechanically supports the waveguide bridge 60 on the bottom of the recess 100, is formed by the size of the holes 110 and 120 next to the waveguide bridge 60. FIG. 14 shows the cross section of the waveguide arrangement 10 along the section line XIV-XIV according to FIG. 13 in the region of the support 400. It can be seen that the support 400 supports the waveguide bridge 60 vertically.

In order to form the support 400, the holes 110 and 120 are for example selected to be smaller in the region of the support 400 than in the other sections of the waveguide arrangement 10, in which supports are not intended to be formed. The size of the holes 110 and 120 in the region of the support 400 is preferably selected in such a way that the lateral etching under the substrate during the production of the recess 100 cannot reach the support 400.

FIG. 15 represents by way of example the formation of a double support 410 consisting of substrate material for vertically supporting the waveguide bridge 60 on the bottom of the recess 100. The formation of the double support 410 is carried out by corresponding selection of the size of the holes 110 and 120 in the region of the future double support.

In order to form the double support 410, the holes 110 and 120 are for example selected to be smaller in the region of the double support 410 than in the other sections of the waveguide arrangement 10, in which supports 400 or double supports 410 are not intended to be formed. The size of the holes 110 and 120 in the region of the double support 410 is preferably selected in such a way that the lateral etching under the substrate during the production of the recess 100 cannot reach the double support 410.

FIG. 16 shows an exemplary embodiment of a waveguide arrangement 10, in which a layer waveguide 500 does not have a constant width but one which is variable along the propagation direction of the wave. It can be seen that the width as seen along the arrow direction L tapers and subsequently widens again. The shape of the layer waveguide 500 as represented in FIG. 16 is to be understood here only as an example. As an alternative, the layer waveguide 500 may also be curved, tapered on two sides or coupled to other waveguides.

The waveguide arrangements explained by way of example in FIGS. 1 to 16 may have one or more of the following properties:
The cross section of the waveguide may be constant.
The cross section of the waveguide may taper or become larger.
The cross section of the waveguide may be rectangular or at least approximately rectangular.
The cross section of the waveguide may be rounded.
The waveguide thickness may be from 100 to 10000 nm.
The thickness of the layer material in the edge sections and/or in the region of the lateral holding webs may be from 5 to 50% of the layer thickness in the waveguiding region of the layer waveguide.
The holes 110 and 120 may have a size of from 1 to 10 μm.
The distances between the holes 110 and 120 may be from 1 to 10 times as great as the hole diameter of the holes 110 and 120.
The layer waveguide may be straight or curved in any desired way.
A plurality of waveguides as described above may be structured closely next to one another or connected directly to one another, so that the waves guided in the waveguides can interact with one another.
A plurality of waveguides with different cross sections may be provided directly behind one another in the waveguide arrangement.
The ends of the layer waveguides may end inside or outside the substrate.
One or more supports consisting of substrate material may stabilize the waveguide bridge below the layer waveguide.
The layer waveguide and the substrate may be surrounded by a vacuum, air or any other desired medium having a refractive index which is less than the refractive index of the layer material.
The distance from the layer waveguide to the substrate is preferably between 100 nm and 10000 nm.
The guiding of the waves takes place in single-mode or multimode fashion.
The holes 110 and 120 and the recess 100 in the substrate may be produced by a technical plasma method or a chemical etching method.
The definition of the openings is preferably carried out in the scope of a photolithographic method.

### LIST OF REFERENCES

10 waveguide arrangement
20 substrate
30 layer material
40 bearing section
50 bearing section
60 waveguide bridge
70 rib waveguide
80 rib section
81 edge section
82 edge section
100 recess
110 hole
110a row of holes
120 hole
120a row of holes
150 holding web
160 holding web
300 photoresist
310 opening
330 photoresist layer
400 support
410 double support
500 layer waveguide
L longitudinal direction

1. A waveguide arrangement (10) having a substrate (20) and at least one strip-shaped strip waveguide consisting of a waveguiding layer material (30), wherein the strip waveguide extends in the shape of a strip along a longitudinal direction and can guide waves along its longitudinal direction in such a way that the wave propagation direction corresponds to the longitudinal direction of the strip waveguide,
wherein the refractive index of the substrate (20) is greater than the refractive index of the layer material (30), and
wherein the strip waveguide forms a waveguide bridge (60) which is arranged above a recess (100) in the substrate (20) and is spatially separated there from the substrate (20) at least in sections.

2. The waveguide arrangement (10) as claimed in claim 1,
characterized in that
the layer material (30) has, outside the region of the strip waveguide, at least one bearing section (40, 50) in which the layer material (30) is carried indirectly or directly by the substrate (20), and the layer material (30) forms, in the neighboring region next to the waveguide, at least one lateral holding web (150, 160) which
extends transversely, in particular perpendicularly, to the longitudinal direction of the strip waveguide and therefore transversely to the wave propagation direction from the bearing section (40, 50) to the waveguide bridge (60), and
holds from the side the waveguide overhanging the substrate (20).

3. The waveguide arrangement (10) as claimed in claim 2,
characterized in that
there are a multiplicity of lateral holding webs (150, 160),
each of the holding webs (150, 160) respectively being bounded by two neighboring holes (110, 120), lying behind one another along the wave propagation direction, which extend through the layer material (30) into the substrate (20), separate the respective holding web (150, 160) from the underlying substrate (20) and are connected to the recess (100) under the waveguide bridge (60).

4. The waveguide arrangement (10) as claimed in claim 1,
characterized in that
the layer thickness of the layer material (30) in the region of the lateral holding webs (150, 160) and/or in the bearing section (40, 50) is less than the thickness of the layer material (30) in the waveguiding section of the strip waveguide.

5. The waveguide arrangement (10) as claimed in claim 1,
characterized in that
the strip waveguide is a rib waveguide (70) which has a waveguiding section (80) consisting of the layer material (30) and two edge sections (81, 82) adjacent thereto consisting of the layer material (30),
the waveguiding section (80) having a first layer thickness and the two edge sections (81, 82) adjacent thereto having a second layer thickness smaller than this.

6. The waveguide arrangement (10) as claimed in claim 5,
characterized in that
the layer thickness of the edge sections (81, 82) corresponds to the layer thickness of the layer material (30) in the bearing section (40, 50) and/or to the layer thickness of the holding webs (150, 160).

7. The waveguide arrangement (10) as claimed in claim 5,
characterized in that
the layer thickness of the layer material (30) in the region of the holding webs (150, 160) is between 5% and 50% of the thickness of the layer material (30) in the waveguiding section of the strip waveguide.

8. The waveguide arrangement (10) as claimed in claim 1,
characterized in that
the waveguide bridge (60) is supported by at least one support (400) which consists of substrate material, extends from the bottom of the recess (100) to the waveguide bridge (60) and supports the waveguide bridge (60) from below.

9. A method for producing a waveguide arrangement (10), wherein
at least one strip waveguide, which extends along a longitudinal direction and can guide waves along its longitudinal direction in such a way that the wave propagation direction corresponds to the longitudinal direction of the strip waveguide, is formed from at least one waveguiding layer material (30) located indirectly or directly on a substrate (20), the waveguiding layer material (30) having a lower refractive index than the substrate (20), and
at least one recess (100) is introduced into the layer material (30) and the substrate (20), and at least one waveguide bridge (60) comprising the strip waveguide is produced, which waveguide bridge is spatially separated from the substrate (20) at least in sections.

10. The method as claimed in claim 9,
characterized in that
at least one bearing section (40, 50), in which the layer material (30) is carried indirectly or directly by a substrate (20), is produced with the layer material (30) outside the region of the strip waveguide, and
a multiplicity of lateral holding webs (150, 160) are produced, each of which extends transversely, in particular perpendicularly, to the longitudinal direction of the strip waveguide and therefore transversely to the wave propagation direction from the bearing section (40, 50) to the waveguide bridge (60) and which holds from the side the waveguide overhanging the substrate (20),
by etching holes (110, 120) lying behind one another along the wave propagation direction through the layer material (30) into the substrate (20) and etching under the region of the strip waveguide.
